(19) United States
(12) Patent Application Publication
(10) Pub. No.: US 2013/0219793 A1
(43) Pub. Date: Aug. 29, 2013

(54) DOOR LOCKING ASSEMBLIES AND ARRANGEMENTS

(71) Applicant: Master Lock Company LLC, (US)

(72) Inventor: Cornelius O'Rourke, Brookfield, WI (US)

(73) Assignee: MASTER LOCK COMPANY LLC, Oak Creek, WI (US)

(21) Appl. No.: 13/774,087

(22) Filed: Feb. 22, 2013

Related U.S. Application Data
(60) Provisional application No. 61/602,210, filed on Feb. 23, 2012.

(51) Int. Cl. E05C 3/12; E05F 1/00

(52) U.S. Cl. CPC E05C 3/12; E05F 1/00
USPC 49/324; 49/394; 49/506

(57) ABSTRACT

A door securing system includes a block member and a brace member. The block member is secured to a door jamb. The brace member including a mounting portion secured to an interior surface of a door, a rail portion extending in a lateral direction from the interior surface of the door, and a flange portion extending in a lateral direction from the rail portion. The interior surface of the door, the rail portion, and the flange portion together define a recess sized and positioned to receive the block member when the door is in the closed position to provide a lock point between the first jamb and the door.

### CROSS-REFERENCE TO RELATED APPLICATION

This application claims priority to and the benefit of U.S. Provisional Patent Application Ser. No. 61/602,210, entitled “DOOR LOCKING ASSEMBLIES AND ARRANGEMENTS” and filed Feb. 23, 2012, the entire disclosure of which is incorporated herein by reference.

### BACKGROUND

Conventional residential and commercial door locks include a user operable locking mechanism that engages and releases a latch or locking bolt with a door frame to provide a locking point between the door and door frame against unauthorized opening of the door. While the locking mechanism of such a lock may be resistant to improper manipulation of the locking mechanism, the locked door may be vulnerable to a “brute force” attack, in which the door is pried open, defeating the weakest material at the interface between the door and door frame, which may be a portion of the lock, the door, or the door frame. Additionally, outward swinging doors with external hinges have additional points of vulnerability, as the hinge pins and/or hinges may be damaged or removed to pull open the hinged end of the door.

### SUMMARY

In an exemplary embodiment of the present application, a door securing system includes a block member and a brace member. The block member is secured to a door jamb. The brace member including a mounting portion secured to an interior surface of a door, a rail portion extending in a lateral direction from the interior surface of the door, and a flange portion extending in a lateral direction from the rail portion. The interior surface of the door, the rail portion, and the flange portion together define a recess sized and positioned to receive the block member when the door is in the closed position to provide a lock point between the first jamb and the door.

In another exemplary embodiment of the present application, an actuator for a button-operated door lock assembly includes an actuator housing, an actuating member, a pivot shaft, an actuating arm, and a paddle. The actuating member is at least partially disposed within the first actuator housing and is slideable along a first axis to an extended position protruding from a first outer wall of the first actuator housing for operative engagement of a button of the door lock assembly. The pivot shaft is disposed within the first actuator housing and is pivotable about a second axis substantially perpendicular to the first axis. The actuating arm is rotationally secured to the pivot shaft and is positioned to engage the actuating member. When the pivot shaft is pivoted from a first orientation to a second orientation, the actuating arm moves the actuating member to the extended position. The paddle is rotationally secured to the pivot shaft for user movement of the pivot shaft from the first orientation to the second orientation.

Another exemplary embodiment of the present application involves a method of securing a hinged end of a door to a door jamb, to prevent movement of the door by disconnecting hinge portions secured to the door and the door jamb. In the exemplary method, a block member is secured to the door jamb and a brace member is secured to an inward facing interior surface of the door to define a recess between the brace member and the door, sized and positioned to receive the block member when the door is in the closed position to provide a first lock point between the first jamb and the door, and to permit withdrawal of the block portion from the recess when the door is pivoted about the hinge axis to the open position. When the hinge portions are disconnected from each other, a pulling force applied to the hinged end of the door from an exterior side of the door causes the block member to abut the flange portion to prevent outward movement of the door, and a pushing force applied to the hinged end of the door from the exterior side of the door causes the block member to abut the interior surface of the door to prevent inward movement of the door.

### BRIEF DESCRIPTION OF THE DRAWINGS

Further features and advantages will become apparent from the following detailed description made with reference to the accompanying drawings, wherein:

FIG. 1 illustrates a perspective view of an interior side of a door assembly, according to an exemplary embodiment;

FIG. 2 illustrates a partial perspective view of a door locking arrangement of the door assembly of FIG. 1, shown in an open position;

FIG. 3 illustrates a partial perspective view of a door locking arrangement of the door assembly of FIG. 1, shown in an open position, with the shell member removed to illustrate additional features of the door locking arrangement;

FIG. 4 illustrates a perspective view of a door lock of the door assembly of FIG. 1;

FIG. 5 illustrates a perspective view of an upper lock releasing mechanism of the door assembly of FIG. 1, with the shell member removed to illustrate additional features of the door locking arrangement;

FIG. 6 illustrates an exploded perspective view of the upper lock releasing mechanism of the door assembly of FIG. 1;

FIG. 7 illustrates a cross-sectional upper perspective view of the upper lock releasing mechanism of the door assembly of FIG. 1;

FIG. 8 illustrates a perspective view of a lower lock releasing mechanism of the door assembly of FIG. 1, with the shell member removed to illustrate additional features of the door locking arrangement;

FIG. 9 illustrates a side perspective view of a hinged end blocking arrangement for a door assembly, according to an exemplary embodiment, shown with the door in a closed position;

FIG. 10 illustrates a lower perspective view of the hinged end blocking arrangement of FIG. 9, shown with the door in a closed position;

FIG. 11 illustrates a side perspective view of the hinged end blocking arrangement of FIG. 9, shown with the door in an open position;

FIG. 12 illustrates a top view of the hinged end blocking arrangement of FIG. 9, shown with the door in an open position;

FIGS. 13A, 13B, 13C, and 13D illustrate upper perspective, top, front, and side views of the block member of the hinged end blocking arrangement of FIG. 9; and

FIGS. 14A, 14B, 14C, and 14D illustrate upper perspective, top, front, and side views of the brace member of the hinged end blocking arrangement of FIG. 9.

### DETAILED DESCRIPTION

This Detailed Description merely describes exemplary embodiments and is not intended to limit the scope of the claims in any way. Indeed, the invention as claimed is broader than and unlimited by the exemplary embodiments, and the terms used in the claims have their full ordinary meaning For example, while the specific embodiments described herein relate to door locks for entry doors, the exemplary embodiments of the present application may additionally or alternatively be applied to other locked barriers or enclosures, including, for example, safes, lockers, and containers.

Exemplary embodiments of the present application provide multiple locking point door locking arrangements configured to impede brute force efforts to pry open the door from a first side of the door (e.g., external to the building or enclosure), and/or to facilitate quick and easy opening of the locked door from a second side of the door (e.g., from within the building or enclosure).

According to an exemplary embodiment of the present application, a door lock assembly, providing a lock point between a door and a door jamb of a door frame and having a lock interface (e.g., a button) disposed on an interior side of the door, may be assembled with an interface engaging mechanism operable by a user on the interior side of the door to engage the lock interface and release the lock point. In one such embodiment, an interface engaging mechanism is provided on the interior side of the door and is configured to engage multiple lock interfaces (e.g., simultaneously, sequentially, or selectively) for multiple lock assemblies to release multiple lock points between the door and the door frame.

A lock interface for a door lock assembly may include any suitable electrical, mechanical, or electromechanical mechanism configured to move the lock assembly from a locked position maintaining the lock point to an unlocked position releasing the lock point. In one embodiment, a door lock assembly has a lock interface that includes a release button that is depressed to unlock a locking mechanism (e.g., an electromechanical or mechanical mechanism) of the lock assembly. While any suitable user operable device may be utilized to engage the release button, in an exemplary embodiment, an actuator interface engaging mechanism assembled with the door and configured to depress the button of one or more such door locks when a user engageable member is operated. In one such embodiment, a user engageable member includes an interface engaging paddle configured to simultaneously operate multiple (e.g., upper and lower) door locks of a door lock assembly for release of multiple associated lock points.

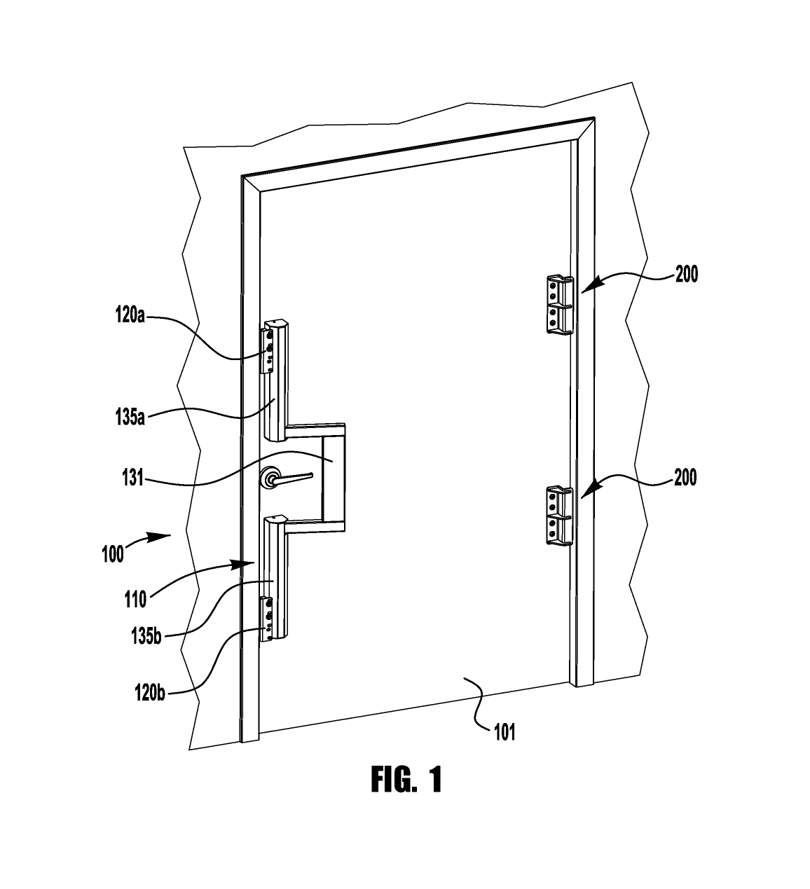

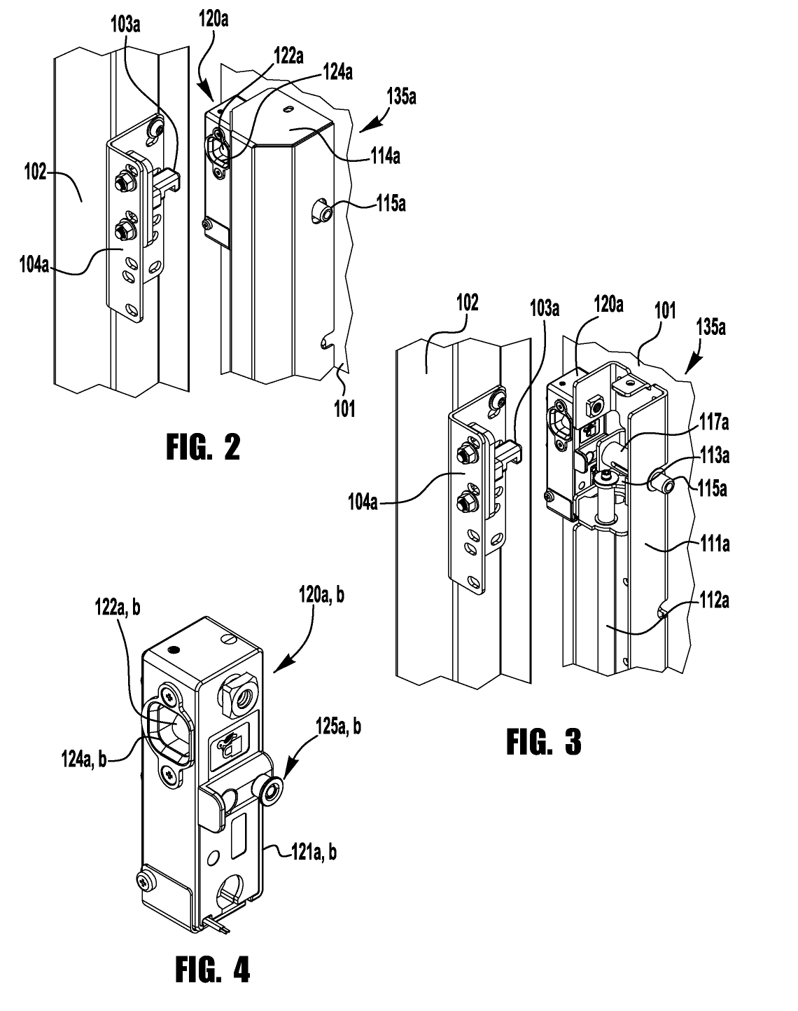

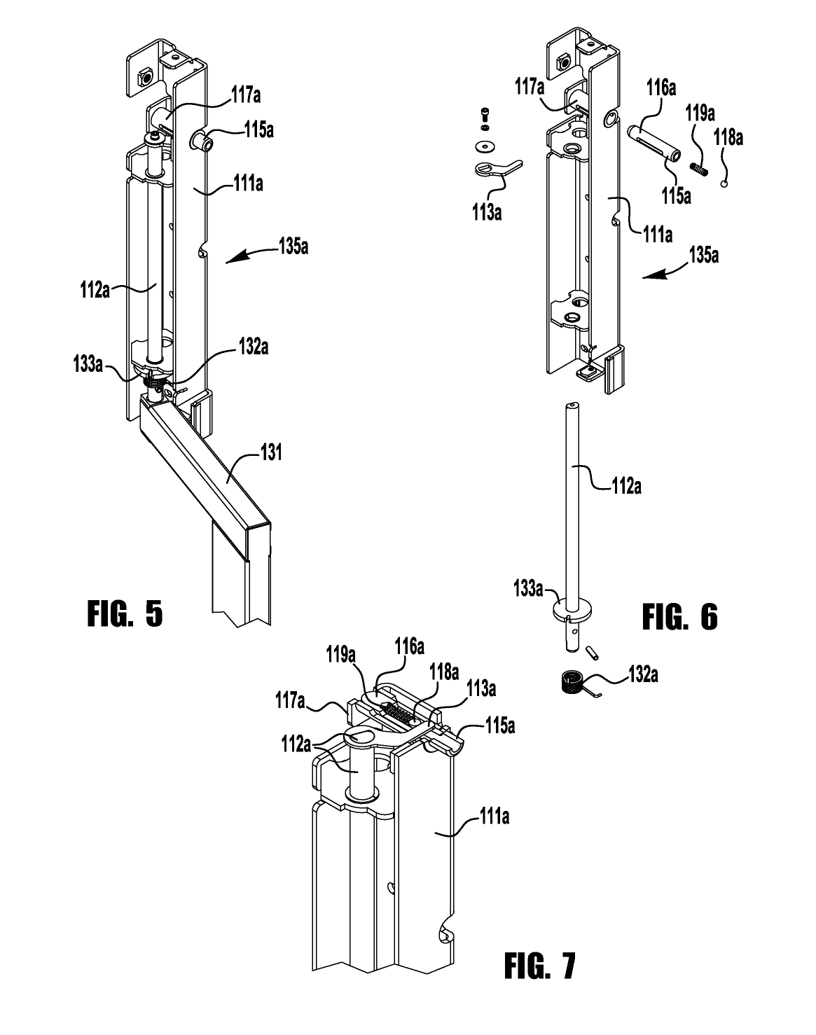

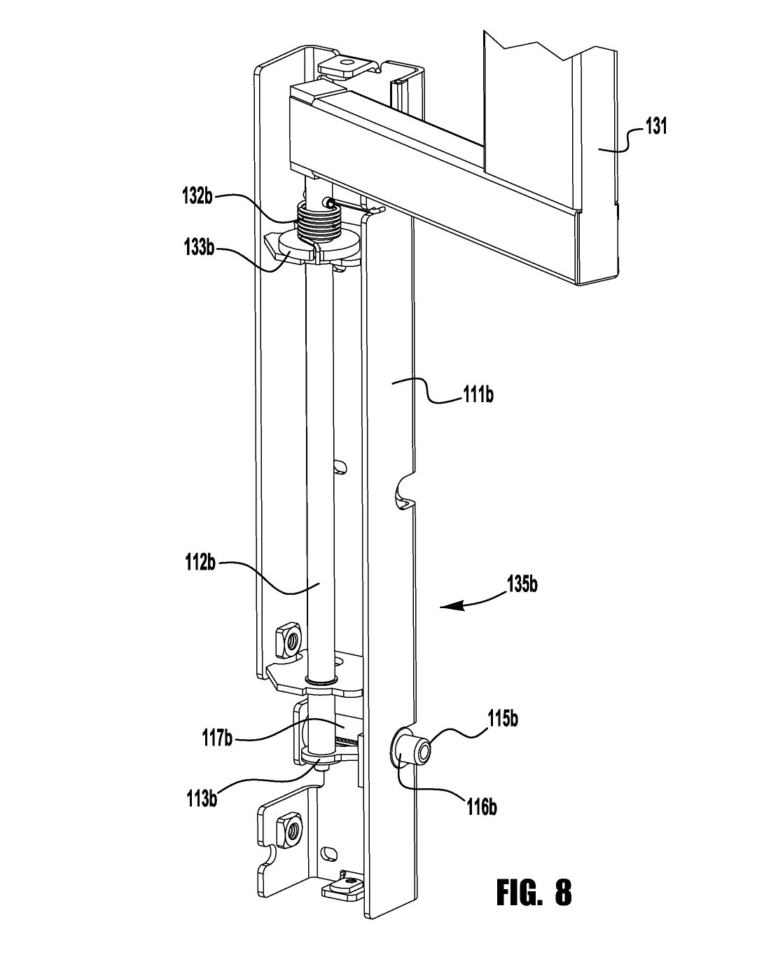

FIGS. 1-8 illustrate various views of a door securing system 100 including an interface engaging actuator 110 assembled with a door 101 for operating upper and lower door locks 120a, 120b assembled with the door 101. As shown in FIG. 4, the exemplary door locks 120a, 120b each include a pivotable latch 122a, 122b disposed in a lock housing 121a, 121b, that interlocks with a corresponding strike member 103a, 103b secured to a door jamb 102 of a door frame (e.g., by mounting brackets 104a, 104b) when the strike member 103a, 103b is received in an opening 124a, 124b in the lock housing 121a, 121b. Each door lock 120a, 120b includes a lock release button 125a, 125b that is manually operable to cause the latch 122a, 122b (e.g., by a mechanical or electromechanical mechanism) to pivot to release the strike member 103a, 103b for opening the door 101. While many different types of door lock assemblies may be utilized, in an exemplary embodiment, solenoid-operated electromechanical locks are provided, as described, for example, in U.S. Patent Application Publication No. 2009/0308117, the entire disclosure of which is incorporated herein by reference. A commercially available example of a solenoid-operated electromechanical lock is the 7236 PulseCode™ lock by Master Lock Company, LLC.

A variety of user engageable members may be utilized to operate one or more lock releasing mechanisms, including, for example, one or more buttons, knobs, levers, or paddles. In the illustrated embodiment, the exemplary actuator 110 includes a user operable paddle member 131 operatively connected to upper and lower lock releasing mechanisms 135a, 135b. The lock releasing mechanisms 135a, 135b include upper and lower pivot shafts 112a, 112b that are secured to the paddle member 131 and pivotally mounted to corresponding actuator housings 111a, 11 lb secured to the door 101. Upper and lower actuating arms 113a, 113b are rotationally secured to the pivot rods 112a, 112b and extend through slotted sleeves 117a, 117b into slotted portions of actuating members (e.g., pins) 116a, 116b (FIG. 7), such that pivoting actuation of the paddle member 131 causes the arms 113a, 113b to move the actuating pins 116a, 116b beyond the sleeves 117a, 117b and against the release buttons 125a, 125b to unlock the door lock assemblies 120a, 120b. The exemplary shafts 112a, 112b are flatted or semicircular in cross-section for assembly with complementary shaped openings in the actuating arms 113a, 113b, to facilitate co-rotation of the shafts and actuating arms.

When assembled with an outward opening door 101, the paddle 131 may be manually pressed to unlock the locks 120a, 120b and open the door 101 in a single motion, provided for efficient opening of the locked door from the inside. As shown, torsion springs 132a, 132b installed between the shafts 112a, 112b and the actuator housings 111a, 11 lb bias the shafts and the paddle member 131 back toward the un-pivoted position. In the illustrated example, a first leg of each torsion spring engages a notched portion of a corresponding keyed washer 133a, 133b (e.g., with a flatted or semicircular opening matching the shaft 112a, 112b), and a second leg of each torsion spring 132a, 132b engages a notch in the corresponding actuator housing 111a, 111b to impart a torsional biasing force between the actuator housing and the shaft. Shell members 114a, 114b may be assembled with the actuator housings 111a, 111b to enclose the paddle operating components. The shell members may also provide a protective enclosure for electrical wiring associated with the door lock assemblies 120a, 120b.

While the actuating arms may be configured to directly engage the actuating pins 116a, 116b, in the illustrated embodiment, the actuating arms 113a, 113b engage spring-loaded bearings 118a, 118b (FIGS. 6 and 7), retained within the actuating pins 116a, 116b, that transmit the applied actuating force through springs 119a, 119b to the actuating pins. This arrangement allows one of the actuating pins 116a, 116b to be further advanced beyond an actuated position of the other actuating pin (i.e., in which the other actuating pin has actuated the corresponding release button), for example, in the event that variations in manufacturing tolerance or installation positioning cause misalignments between the actuated positions of the two buttons 125a, 125b. Where the actuated positions of the actuating pins 116a, 116b do not coincide, the spring 119a, 119b associated with the actuating pin 116a, 116b that reaches the actuated position first compresses to allow for additional paddle member travel, and further actuation of the other actuating pin. The springs 119a, 119b may each have an uncompressed spring resistance greater than a force required to move the corresponding first and second actuating members to the extended, button actuating position. This condition prevents compression of the springs 119a, 119b until the corresponding actuating pins 116a, 116b have been extended to operate the corresponding buttons 125a, 125b, thereby minimizing the required movement of the paddle member 131.

According to another exemplary feature, to allow for selective manual actuation of one of the lock assemblies 120a, 120b (e.g., in the event of a paddle mechanism failure, or in applications in which actuation of only one of multiple lock assemblies may be desired), an override button 115a, 115b may be attached to (e.g., assembled with or integral to) the actuating pin 116a, 116b and extending from the shell member 114a, 114b for manual actuation by the user.

According to another exemplary feature of the present application, a hinged, outward swinging door may be provided with a hinged end blocking arrangement configured to impede attempts to pry open a door after removing the hinge pins or hinges from the door and/or door jamb. In one such embodiment, a hinged end bracing arrangement includes a block member secured to the door frame, and a brace member secured to the other of the door hinged end, with the block member being received within a recess defined by the brace member when the door is in a closed position. The block member and brace member are sized and positioned such that pivoting movement of the unlocked door about the hinge axis withdraws the block member from the brace member recess, while pulling or pushing of the hinged end of the door (e.g., after removal of the hinges or hinge pins from the door) is blocked by engagement between the block member and the brace member (when pulling) or the door (when pushing).

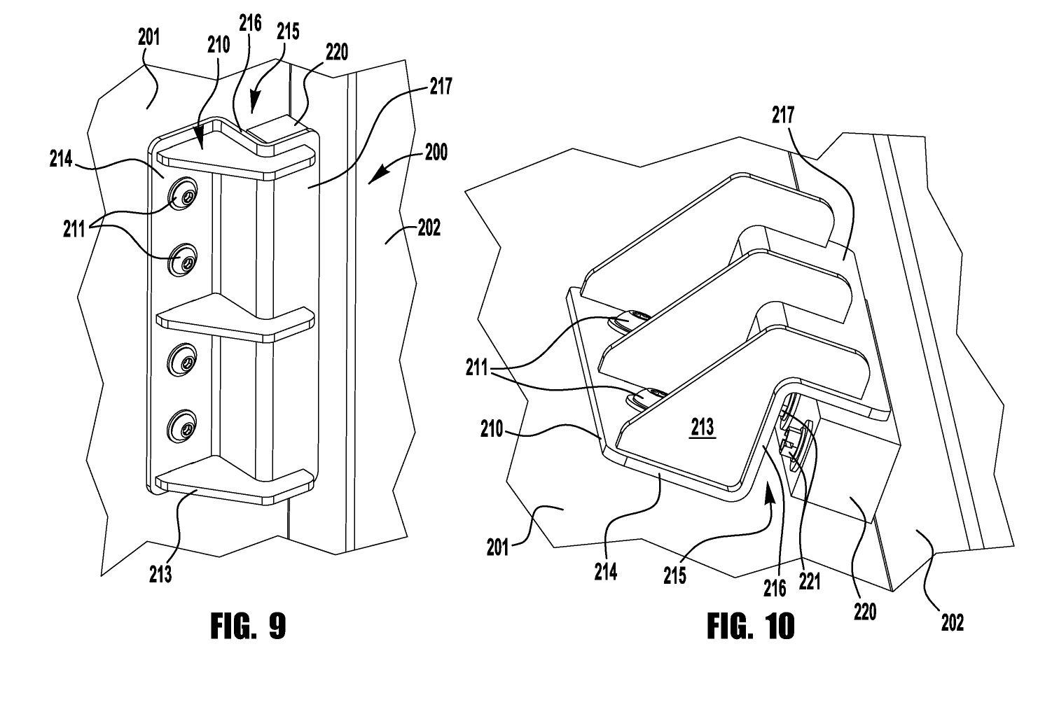

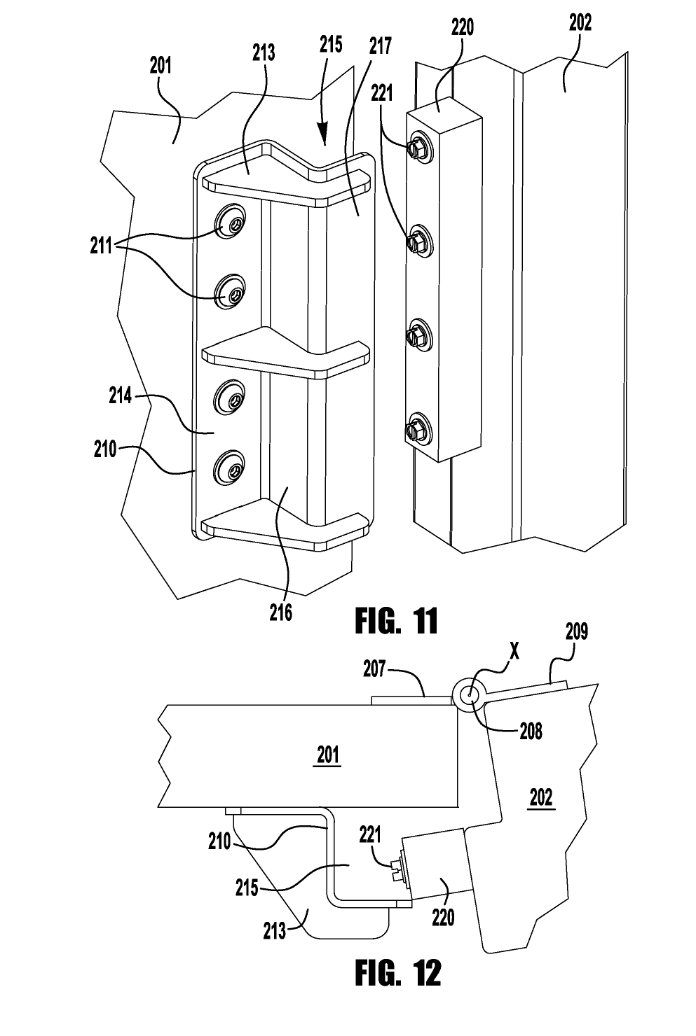

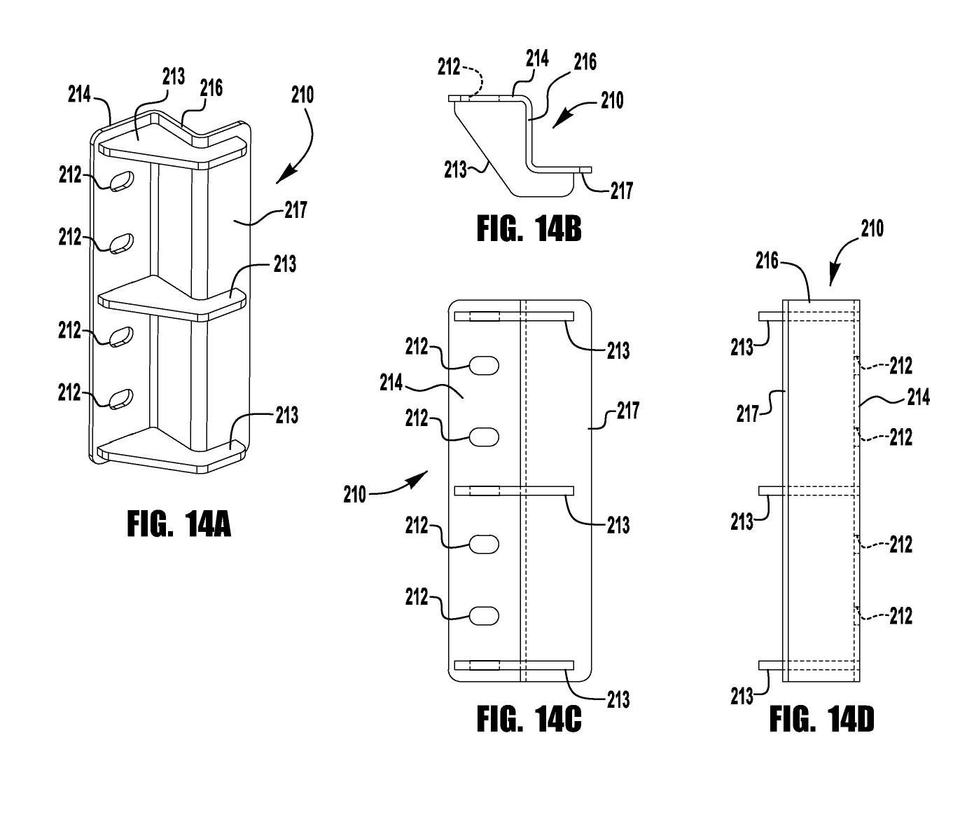

In the illustrated embodiment of FIGS. 9-14D, a hinged end blocking arrangement 200 includes a brace member 210 secured to a door 201 (e.g., by bolts 211 securing a mounting portion 214 to an interior surface of the door) and a block member 220 secured to a door jamb 202 (e.g., by bolts 221). The brace member 210 includes a rail portion 216 extending in a lateral direction from the mounting portion 214 and the interior surface of the door, and a flange portion 217 extending in a lateral direction from the rail portion. The interior surface of the door 201, the rail portion 216, and the flange portion 217 together define a recess 215 sized to receive the block member 220 in the door's closed position, while permitting pivoting movement of the door 201 about the hinge axis X, defined by a hinge pin 208 pivotably connecting a first hinge portion 207 secured to the door 201 and a second hinge portion 209 secured to the door jamb 202. The brace member 210 and block member 220 may be sized, shaped, and/or positioned to provide interference between the block member 220 and the brace member 210 (when pulling on the hinged end of the door) and between the door 201 and the block member (when pushing on the hinged end of the door), while permitting withdrawal of the block member 220 from the brace member recess 215 when the door is pivoted outward (i.e., in an opening direction) about the hinge axis X. In the illustrated embodiment, the block member 220 and the recess 215 are substantially rectangular in cross-section, although other shapes and configurations may be used.

As shown, the brace member 210 may include reinforcing ribs 213 sized and positioned to reinforce the brace member against bending forces resulting from attempts to pull or pry the hinged end of the door outward or push or ram the hinged end of the door inward, after removing one or more of the hinge portions 207, 209 and hinge pin 208.

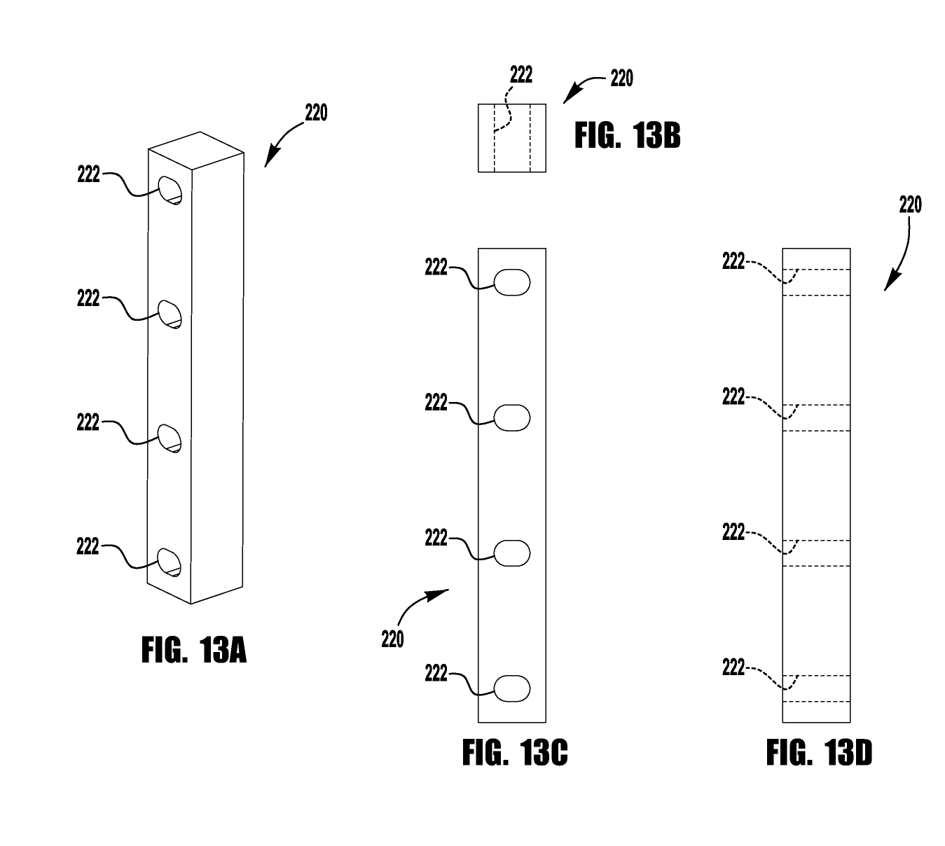

While the block member and brace member may be provided in any suitable material, in one embodiment, the block member and brace member are provided in a high strength metal, including, for example, stainless steel. As shown in FIGS. 13A-D and 14A-D, the brace member 210 and/or block member 220 may be provided with elongated mounting holes 212, 222, to allow the positions of the brace member and block member to be selectively adjusted (to facilitate or improve clearance between the brace member from the block member when pivoting about the hinge axis X, or to increase interference between the brace member and block member when laterally moving the hinged end of the door).

In an exemplary embodiment of the present application, multiple door locks (e.g., the exemplary door locks 120a, 120b of FIGS. 1-4) and a multiple lock releasing mechanism (e.g., the exemplary paddle assembly 110 of FIGS. 1-8) may be used in combination with one or more hinged end blocking arrangements (e.g., the hinged end blocking arrangement 200 of FIGS. 9-14D), to provide a door with three or more lock points. In one such example, as shown in FIG. 1, a door securing system 100 may include a multiple lock releasing mechanism 110 configured to manually release two door locks 120a, 120b provided on a free end of the door 101, and two hinged end blocking arrangements 200 assembled to the door jamb 102 and the hinged end of the door 101. Using such an arrangement, four secure lock points may be released from the interior side of the door merely by pressing on the paddle member and pivoting the door to the open position. The lock releasing mechanism and one or more hinge end blocking arrangements may also be used separately or jointly on a single door to provide any number of secure lock points or a single secure lock point on a door.

While various aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A door securing system comprising:
a door frame including first and second jambs;
a door disposed between the first and second jambs and including opposed outward facing exterior and inward facing interior surfaces extending from a first end adjacent the first jamb to a second end adjacent the second jamb when the door is in a closed position;
a first hinge portion secured to the first jamb;
a second hinge portion secured to the door proximate the first end, the second hinge portion being hingedly connected to the first hinge portion for pivoting movement of the door about a hinge axis between the closed position and an open position;
a block member secured to the second jamb;
a brace member including a mounting portion secured to the interior surface of the door proximate the second end, a rail portion extending in a lateral direction from the interior surface of the door, and a flange portion extending in a lateral direction from the rail portion;
wherein the interior surface of the door, the rail portion, and the flange portion together define a recess sized and positioned to receive the block member when the door is in the closed position to provide a first lock point between the first jamb and the door;
further wherein when the first hinge portion is disconnected from the second hinge portion, a pulling force applied to the first end from an exterior side of the door causes the block member to abut the flange portion to prevent outward movement of the door, and a pushing force applied to the first end from the exterior side of the door causes the block member to abut the interior surface of the door to prevent inward movement of the door.

2. The system of claim 1, wherein the block member is secured to an inner surface of the first jamb facing the second jamb.

3. The system of claim 1, wherein the block member is substantially rectangular in cross-section.

4. The system of claim 1, wherein the recess is substantially rectangular in cross-section.

5. The system of claim 1, further comprising a second block member secured to the second jamb, and a second brace member secured to the interior surface of the door, to provide a second lock point between the first jamb and the door when the door is in the closed position.

6. The system of claim 1, further comprising a locking mechanism assembled with at least one of the door and the second jamb, for selective locking engagement of the door with the second jamb when the door is in the closed position;

7. The system of claim 6, wherein the locking mechanism comprises a strike member secured to the second jamb and a lock assembly assembled to the interior surface of the door proximate the second end, the lock assembly being configured to interlock with the strike member when the door is in the closed position and the lock assembly is in a locked condition.

8. The system of claim 6, wherein the locking mechanism comprises a lock assembly including a first latch and a first button operable to move the first latch from a locked condition to an unlocked condition.

9. The system of claim 8, further comprising an actuator including:
a first actuator housing mounted to the interior surface of the door;
a first actuating member at least partially disposed within the first actuator housing and slideable along a first axis to an extended position protruding from a first outer wall of the first actuator housing for operative engagement of the first button;
a first pivot shaft disposed within the first actuator housing and pivotable about a second axis substantially perpendicular to the first axis;
a first actuating arm rotationally secured to the first pivot shaft and positioned to engage the first actuating member, wherein when the first pivot shaft is pivoted from a first orientation to a second orientation, the first actuating arm moves the first actuating member to the extended position; and
a user engageable member rotationally secured to the first pivot shaft for user movement of the first pivot shaft from the first orientation to the second orientation.

10. The system of claim 1, wherein the defined recess is sized and positioned to permit withdrawal of the block portion from the recess when the door is pivoted about the hinge axis to the open position.

11. An actuator for a button-operated door lock assembly, the actuator comprising:
a first actuator housing for mounting to a door;
a first actuating member at least partially disposed within the first actuator housing and slideable along a first axis to an extended position protruding from a first outer wall of the first actuator housing for operative engagement of a first button of the door lock assembly;
a first pivot shaft disposed within the first actuator housing and pivotable about a second axis substantially perpendicular to the first axis;
a first actuating arm rotationally secured to the first pivot shaft and positioned to engage the first actuating member, wherein when the first pivot shaft is pivoted from a first orientation to a second orientation, the first actuating arm moves the first actuating member to the extended position; and
a user engageable member rotationally secured to the first pivot shaft for user movement of the first pivot shaft from the first orientation to the second orientation.

12. The actuator of claim 11, further comprising a first spring member assembled with the first pivot shaft for biasing the first pivot shaft toward the first orientation.

13. The actuator of claim 11, wherein when the first pivot shaft is pivoted from the second orientation to the first orientation, the first actuating arm moves the first actuating member to a retracted position.

14. The actuator of claim 11, wherein the first actuating arm extends through a slot in the first actuating member.

15. The actuator of claim 11, wherein the first actuating member extends through a second outer wall of the actuator housing opposite the first outer wall, for direct user movement of the first actuating member.

16. The actuator of claim 11, further comprising:
a second actuator housing for mounting to the door;
a second actuating member at least partially disposed within the second actuator housing and slideable along a third axis to an extended position protruding from a first outer wall of the second actuator housing for operative engagement of a second button of the door lock assembly;
a second pivot shaft disposed within the second actuator housing and pivotable about the second axis, wherein the user engageable member is rotationally secured to the second pivot shaft for user movement of the second pivot shaft from a first orientation to a second orientation;
a second actuating arm rotationally secured to the second pivot shaft and positioned to engage the second actuating member, wherein when the second pivot shaft is pivoted from the first orientation to the second orientation, the second actuating arm moves the second actuating member to the extended position.

17. The actuator of claim 16, further comprising first and second compression springs disposed between each of the first and second actuating arms and the corresponding first and second actuating members, wherein each of the first and second compressions springs has uncompressed spring resistance greater than a force required to move the corresponding first and second actuating members to the extended position.

18. The actuator of claim 11, wherein the user engageable member comprises a paddle.

19. A method of securing a hinged end of a door to a door jamb, to prevent movement of the door by disconnecting hinge portions secured to the door and the door jamb, the method comprising:
securing a block member to the door jamb; and
securing a brace member to an inward facing interior surface of the door to define a recess between the brace member and the door, sized and positioned to receive the block member when the door is in the closed position to provide a first lock point between the first jamb and the door, and to permit withdrawal of the block portion from the recess when the door is pivoted about the hinge axis to the open position;
wherein when the hinge portions are disconnected from each other, a pulling force applied to the hinged end of the door from an exterior side of the door causes the block member to abut the flange portion to prevent outward movement of the door, and a pushing force applied to the hinged end of the door from the exterior side of the door causes the block member to abut the interior surface of the door to prevent inward movement of the door.

20. The method of claim 19, wherein securing the block member to the door jamb comprises securing the block member to an inner surface of the door jamb facing the door.

21. The method of claim 19, wherein the block member is substantially rectangular in cross-section.

22. The method of claim 19, wherein the recess is substantially rectangular in cross-section.
